(19) United States
(12) Patent Application Publication
(10) Pub. No.: US 2011/0008247 A1
(43) Pub. Date: Jan. 13, 2011

(54) METHOD FOR SELECTIVELY STORING GAS BY CONTROLLING GAS STORAGE SPACE OF GAS STORAGE MEDIUM

(75) Inventors: Yong Ju YUN, Daejeon (KR); Han Young Yu, Daejeon (KR); Byung Hoon Kim, Incheon (KR); Soon Young Oh, Daejeon (KR); Won Gi Hong, Seoul (KR); Yark Yeon Kim, Daejeon (KR); Chang Hee Kim, Busan (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/698,280

(22) Filed: Feb. 2, 2010

(30) Foreign Application Priority Data
Jul. 7, 2009 (KR) 10-2009-0061594

(51) Int. Cl. C01B 3/02

(52) U.S. Cl. 423/648.1

(57) ABSTRACT

Provided is a gas storage method of a gas storage medium having a multilayer structure in which crystalline structures are stacked to be spaced from each other, including selectively storing gas by relatively controlling a space between the crystalline structures or a lattice distance between crystals of each crystalline structure with respect to the van der Waals diameter of gas which is to be stored. According to the gas storage method, it is possible to selectively store gas.

### CROSS-REFERENCE TO RELATED APPLICATION

This application claims priority to and the benefit of Korean Patent Application No. 10-2009-0061594, filed Jul. 7, 2009, the disclosure of which is incorporated herein by reference in its entirety.

### BACKGROUND

1. Field of the Invention

The present invention relates to a method for selectively storing gas by changing the structure of a gas storage medium, and more specifically, to a method for selectively storing gas by controlling a structural change of a gas storage medium, i.e., a space between crystalline structures or a lattice distance between crystals of a crystalline structure in the gas storage medium having a layered structure in which the crystalline structures are stacked to be spaced from each other.

2. Discussion of Related Art

Recently, problems related to environmental pollution such as the exhaustion of fossil fuels and global warming have become serious problems worldwide. Therefore, enormous interest has been focused on hydrogen as an infinitely clean energy source, and various studies have been conducted on the hydrogen energy. To use hydrogen as an energy source, technical development is required in production, storage, transfer, and conversion fields of hydrogen. Particularly, in order for hydrogen energy to be used as a basic industrial material and a domestic fuel or applied to hydrogen vehicles, fuel cells and so on, a hydrogen storage technique that is effective and convenient to use should be developed.

Hydrogen storage methods currently in common use include a gas hydrogen storage method, a liquid hydrogen storage method, a hydrogen storage alloy and so on. However, since they do not guarantee safety and efficiency, they are difficult to use in non-industrial fields. To make up for such disadvantages, hydrogen storage methods using physical adsorption are being actively studied. In particular, studies on nanomaterials having a large specific surface area, a porous property, or a multilayer structure are being actively conducted.

Carbon nanotubes, which are nanomaterials having a long nano-channel and a large specific surface area, have been considered to be the most suitable hydrogen storage materials. At the early stage, it was reported that a hydrogen storage amount of the carbon nanotubes had reached a commonly available level of 4 wt % at room temperature to a maximum of 10 wt % at a low temperature, and the studies are being conducted by many scientists. According to recently published papers, however, the hydrogen storage amount of the carbon nanotubes shows a tendency to decrease. Recently, studies in which alkali metals that easily adsorb hydrogen are doped to increase a hydrogen storage amount have been conducted. However, the mechanism for hydrogen storage is not clear, and the reproducibility of most results is questionable. Therefore, they have been a subject of controversy.

Examples of materials coming into the spotlight as porous hydrogen storage materials include a metal-organic framework having a large specific surface area, a large pore volume, and a small pore size. The metal-organic framework is a crystalline mixture in which metal ions and organic molecules are combined to form a hollow three dimensional structure. It was reported that the metal-organic framework, in which zinc nitrates are used as the metal ions and dicarboxylic acids are used as the organic molecules, had been used to prepare MOF-5 having a hydrogen storage amount of 4.5 wt % at 77K, which shows a possibility as a hydrogen storage medium. Recently, results of a study have shown that a hydrogen adsorption amount of more than 6 to 7 wt % was obtained in low-temperature and high-temperature adsorptions of MOF-177 having a large micropore volume and a large surface area. However, the maximum hydrogen storage amount thereof is insufficient for common use. Further, when MOS-177 is exposed to the air, it becomes unstable.

When such a hydrogen storage medium is used to store hydrogen, other gases as well as hydrogen are adsorbed because of a large distance between lattice points, which makes the efficiency of hydrogen storage low.

### SUMMARY OF THE INVENTION

The present invention is directed to a gas storage method which can not only sufficiently secure a surface area for gas storage to increase gas storage efficiency, but also control the size of a gas storage space of a gas storage medium to selectively store gas.

One aspect of the present invention provides a gas storage method of a gas storage medium having a multilayer structure in which crystalline structures are stacked to be spaced from each other, including selectively storing gas by relatively controlling a space between the crystalline structures or a lattice distance between crystals of each crystalline structure with respect to the van der Waals diameter of gas which is to be stored.

In the gas storage method, the space between the crystalline structures or the lattice distance between crystals of each crystalline structure may be controlled by changing the temperature of a heat treatment of the gas storage medium or by introduction of a chemical reaction group during sample synthesis of the gas storage medium.

The chemical reaction group may be an organic compound containing an amine group (NH₂). Specifically, the chemical reaction group may include one or more selected from the group consisting of methylamine, ethylamine, propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, ammonia, dimethylamine, trimethylamine, and aniline.

In the gas storage method, the crystalline structure may be formed in such a shape that a plurality of crystals are consecutively joined to form one crystalline structure as a whole. The crystalline structure may have a layered or cubical structure.

In the gas storage method, the crystalline structure may include a transition metal, a compound with a transition metal, or a transition metal oxide. As the transition metal, one or more may be selected from the group consisting of Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, and Hg. The crystalline structure may be a vanadium pentoxide crystalline structure.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view of a gas storage medium according to exemplary embodiments of the present invention;

FIGS. 2A to 2C are three-dimensional side and plan views of the gas storage medium according to exemplary embodiments of the present invention;

FIG. 3 is a graph showing X-ray diffractometer (XRD) results of a vanadium pentoxide form before a heat treatment according to exemplary embodiments of the present invention;

FIG. 4 is a transmission electron microscope (TEM) photograph of a vanadium pentoxide form before a heat treatment according to exemplary embodiments of the present invention;

FIG. 5 is a graph showing heat analysis (DSC-TGA) results of the vanadium pentoxide form according to exemplary embodiments of the present invention;

FIG. 6 is a graph showing XRD results of the vanadium pentoxide form after the heat treatment according to exemplary embodiments of the present invention;

FIG. 7 is a TEM photograph of the vanadium pentoxide form after the heat treatment according to exemplary embodiments of the present invention;

FIG. 8 is a graph showing nitrogen and hydrogen adsorptions of the vanadium pentoxide form according to exemplary embodiments of the present invention; and

FIG. 9 is a graph showing hydrogen adsorption results depending on pressure changes of the vanadium pentoxide form according to exemplary embodiments of the present invention.

### DETAILED DESCRIPTION OF EXEMPLARY EMBODIMENTS

Hereinafter, exemplary embodiments of the present invention will be described in detail with reference the accompanying drawings such that the technical idea of the present invention can be easily understood by those skilled in the art. Further, components represented by like reference numerals across this specification indicate the same elements.

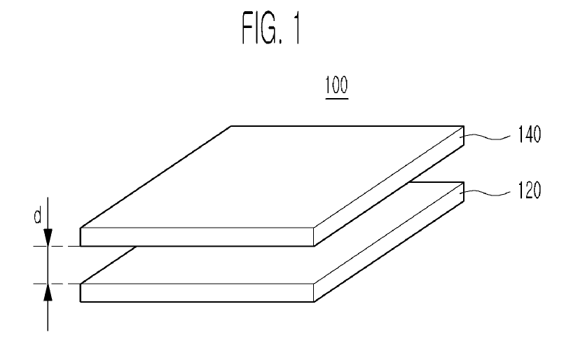

FIG. 1 is a perspective view of a gas storage medium according to an exemplary embodiment of the present invention.

Referring to FIG. 1, the gas storage medium 100 includes an upper crystalline structure 110 and a lower crystalline structure 120 which are stacked to be spaced from each other. Each crystalline structure is formed in such a shape that a plurality of crystals are consecutively joined to form one crystalline structure as a whole. Such a gas storage medium 100 has a predetermined space d provided between the upper crystalline structure 110 and the lower crystalline structure 120. Such a space may be changed by heat-treating the gas storage medium 100. Each of the crystalline structures 110 and 120 may have an empty space provided between crystals (lattice points), in addition to the above-described space. The lattice spacing may be also changed by a heat treatment.

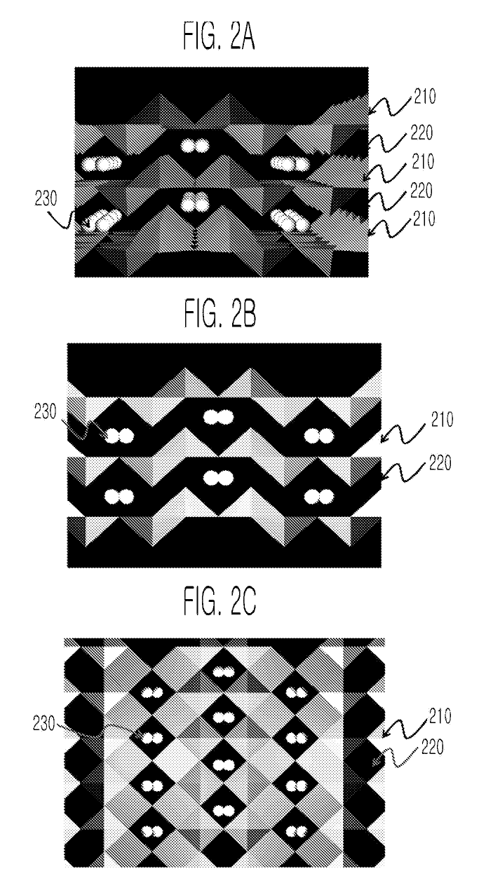

FIGS. 2A to 2C are three-dimensional side and plan views of the gas storage medium according to an exemplary embodiment of the present invention.

Referring to FIGS. 2A to 2C, the gas storage medium 200 has a space 220 provided between crystalline structures 210, and includes gas 230 stored in the space 220.

The size of the space between the crystalline structures 210 may be adjusted to select gas which is to be stored. Therefore, when the space between the crystalline structures 210, in which gas is stored, has a larger size than the van der Waals diameter of the gas, the gas can be stored therein. On the other hand, when the space has a smaller size than the van der Waals diameter of gas, the gas cannot be stored therein.

Further, a distance between crystals of the crystalline structure 210, that is, a distance between lattice points, may be adjusted to select gas which is to be stored. Therefore, when the lattice spacing is smaller than or the same as the van der Waals diameter of the gas, the gas cannot be stored therein.

The adjustment of the space between the crystalline structures 210 or the distance between crystals of each crystalline structure 210 may be controlled by temperature control during a heat treatment, or by introduction of a chemical reaction group when samples of a gas storage medium are synthesized.

The heat treatment refers to a process required for crystallization in a process of preparing crystalline structures used for manufacturing a gas storage medium. As the temperature of the heat treatment is controlled, it is possible to control the distance of the space between the crystalline structures.

The above-described chemical reaction group is introduced during a process of preparing crystalline structures, and is desorbed after the crystalline structures are prepared.

As the chemical reaction group, all organic compounds including an amine group may be used. For example, the chemical reaction group may include one or more selected from the group consisting of methylamine, ethylamine, propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, ammonia, dimethylamine, trimethylamine, and aniline Depending on the type of the chemical reaction group, the size of the gas storage space can be controlled.

The crystalline structure 210 may have a layered structure including plates, but may have a cubical structure. Further, the crystalline structure may include a transition metal. As the transition metal, one or more may be selected from the group consisting of Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, and Hg. Further, a compound with a transition metal or a transition metal oxide may be used. Preferably, a vanadium pentoxide crystalline structure may be used.

Hereinafter, exemplary embodiments of the present invention will be described in further detail.

### Exemplary Embodiments

### Preparing Vanadium Pentoxide Form

First, as organic molecules, 1.33 g of 1-hexadecylamine (C₁₆H₃₃NH₂) was put into 10 ml of acetone, and then refluxed for 30 minutes. Subsequently, 1 g of vanadium pentoxide (V₂O₅) powder was added to the 1-hexadecylamine solution, refluxed for 20 minutes, and then added to 50 ml of a hydrogen peroxide (H₂O₂) solution. An exothermic reaction occurred, and a vanadium pentoxide form was obtained.

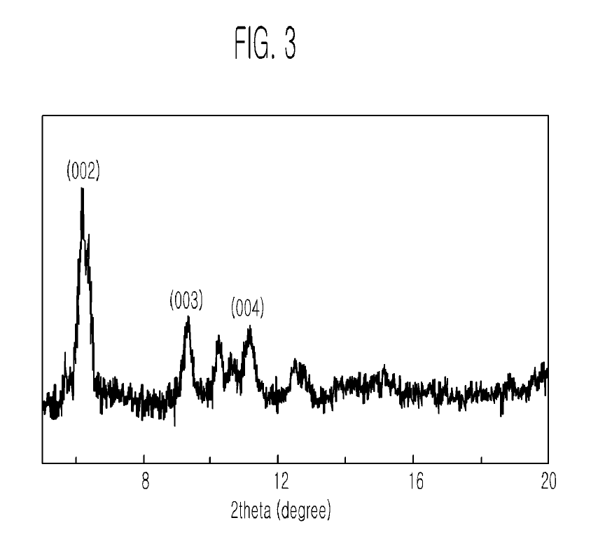

The vanadium pentoxide form obtained in the above-described manner was checked through an X-ray diffractometer (XRD), and the result is shown in FIG. 3. Around 2θ=6°, (002) peak showed up, and an interlayer distance calculated from the peak was 33.4 Å. Therefore, it can be found that this interlayer distance is much larger than an interlayer distance (d=11.5 Å) of V₂O₅.1.6H₂O gel obtained by a reaction between vanadium pentoxide and hydrogen peroxide without 1-hexadecylamine.

This means that the 1-hexadecylamine was well inserted between vanadium pentoxide layers as the organic molecules, and the interlayer distance of the vanadium pentoxide was controlled depending on the size of the amine as the organic molecules.

Checking Structure of Vanadium Pentoxide Form

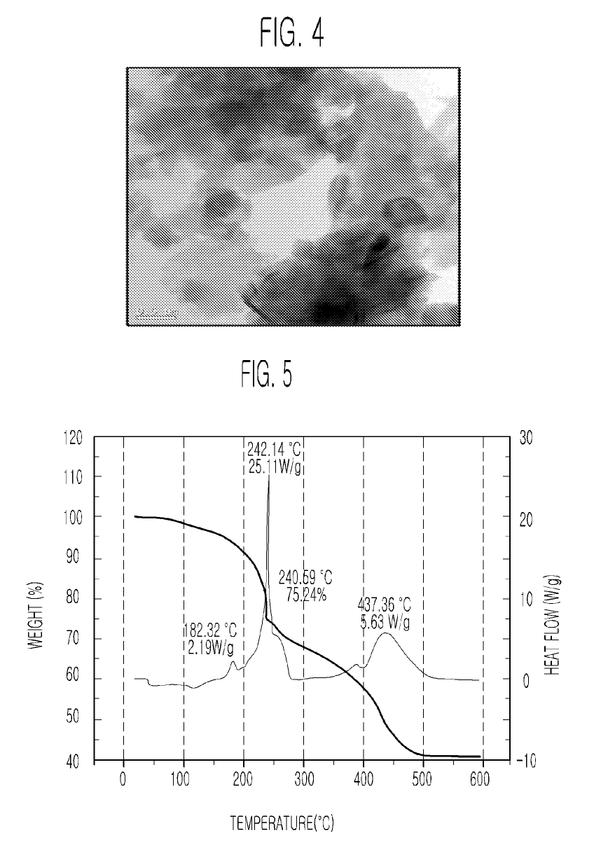

The vanadium pentoxide form prepared in the above-described manner was photographed by a transmission electron microscope (TEM), and the result is shown in FIG. 4. Referring to FIG. 4, most materials are composed of amorphous structures, and few materials having crystallinity are seen. Through energy-dispersive X-ray spectroscopy (EDX) measurement, however, it can be found that most materials are composed of vanadium components and pentoxide components.

Heat Treatment of Vanadium Pentoxide Form

To examine a content of water contained in the vanadium pentoxide form and a temperature at which the crystallization occurs, a thermogravimetric analyzer (TGA) and a differential scanning calorimeter (DSC) were used to perform an analysis. For this analysis, SDT2860 Simultaneous DSC-TGA, manufactured by TA Instruments, was used, the measurement temperature ranged from room temperature to 600 r, and a thermal analysis was performed at a temperature increasing rate of 5° C./m. The result is shown in FIG. 5. Referring to FIG. 5, it can be found that a rapid weight reduction occurs at around 240° C. This reduction occurs when amine molecules inserted between the vanadium pentoxide layers are desorbed. The temperature is related to the result (242.14° C.) of the DSC, and a weight reduction at a region of 400 to 500° C. occurs when residual organic matters existing in the vanadium pentoxide form are desorbed. Further, it can be found from the DSC data that the vanadium pentoxide form is crystallized at 437.36° C.

Checking Crystalline Structure after Heat Treatment

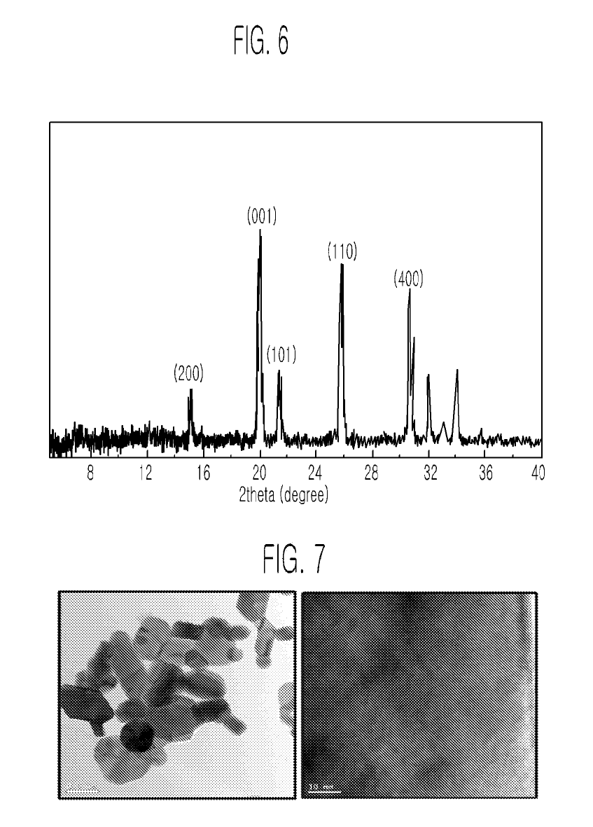

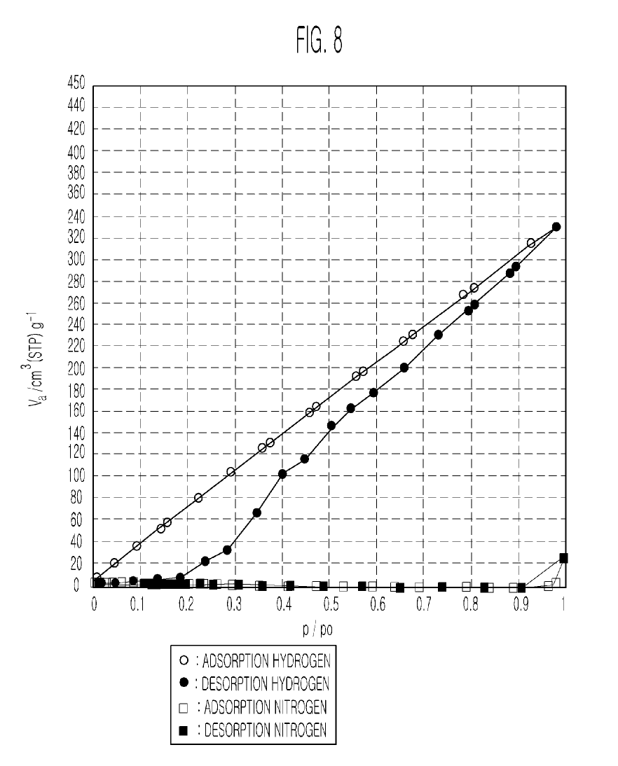

Samples were heat-treated for five fours at 600° C., which are crystallization conditions of the vanadium pentoxide form, and then evaluated by the XRD. The result is shown in FIG. 6. Unlike the result of FIG. 3, the result of FIG. 6 corresponds to an XRD graph of a crystallized vanadium pentoxide form having an interlayer distance of 4.36 to 4.38 Å. FIG. 7 is a TEM photograph of the crystallized vanadium pentoxide form. Unlike FIG. 4, it can be found that most materials were crystallized. Further, it can be found from the right-side high-resolution image that the interlayer distance of the crystallized vanadium pentoxide form is about 4.5 to 5 Å.

Gas Adsorption Characteristics

Adsorption characteristics of the crystallized vanadium pentoxide form on nitrogen and hydrogen gases were evaluated, and the result is shown in FIG. 8. This experiment was performed to see the amount of gas adsorbed when the pressure of the gas whose adsorption characteristics are to be evaluated at a nitrogen temperature is raised up to one atmospheric pressure. As shown in the graph of FIG. 8, a specific surface area and a pore size could not be clearly found because the nitrogen gas was not adsorbed. On the other hand, the hydrogen gas was adsorbed as much as about 330 cm³(STP)g⁻¹ at one atmospheric pressure, which indicates that the vanadium pentoxide form selectively adsorbs only the hydrogen gas.

Hydrogen Gas Adsorption Characteristics

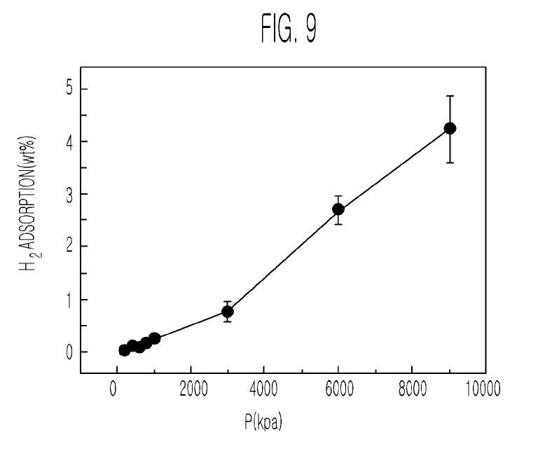

A hydrogen storing ability of the crystallized vanadium pentoxide form depending on atmospheric pressure was evaluated, and the result is shown in FIG. 9. Equipment for evaluating hydrogen storage performance was used to measure a hydrogen storing ability in a region of the atmospheric pressure to 100 atmospheric pressures at room temperature and a low temperature (77K), respectively. At room temperature, the hydrogen storage ability was close to zero, and at a high pressure of 90 atmospheric pressures, the hydrogen storage ability was also close to zero. On the other hand, as shown in the graph of FIG. 9, it can be found that the hydrogen storage ability gradually increases (0.76 wt % at 30 atmospheric pressures, 2.69 wt % at 60 atmospheric pressures, and 4.23 wt % at 90 atmospheric pressures) at 77K.

Through such an experiment, it can be seen that the vanadium pentoxide form adsorbs hydrogen, but does not adsorb nitrogen. This means that because the van der Waals diameter of hydrogen gas is smaller than that of nitrogen gas and the distance between the vanadium pentoxide crystalline structures, hydrogen can be adsorbed, but nitrogen is not adsorbed (selective hydrogen adsorption).

According to the present invention, it is possible to obtain the following effects. First, the lattice size of a crystalline structure having a layered structure is adjusted to widen a surface area as such as the adjusted lattice size. Second, in the layered structure having crystalline structures spaced from each other, the interlayer space or the distance between crystals of each crystalline structure is adjusted to selectively store gas.

While the invention has been shown and described with reference to certain exemplary embodiments thereof, the exemplary embodiments have been taken for the descriptions of the present invention, and the present invention is not limited thereto. In particular, the vanadium pentoxide crystalline structure is taken as a specific example in this invention, but the gas storage medium according to this invention is not limited only to the vanadium pentoxide crystalline structure. As described above, a storage medium formed by a combination of a transition metal, other metals, and elements, a bulk-type storage medium composed of crystalline structures thereof, and a compound which is chemically combined with a transition metal may all be included, and crystals of the storage media can be established in a multilayer structure, that is, in such a structure that a space can be secured between layers. Further, a structure including materials which can be easily discharged during sample synthesis or a structure which is to be removed after synthesis may be applied. Further, it will be understood by those skilled in the art that various changes in form and details may be made therein without departing from the spirit and scope of the invention as defined by the appended claims.

What is claimed is:

1. A gas storage method of a gas storage medium having a multilayer structure in which crystalline structures are stacked to be spaced from each other, comprising selectively storing gas by relatively controlling a space between the crystalline structures or a lattice distance between crystals of each crystalline structure with respect to the van der Waals diameter of gas which is to be stored.

2. The gas storage method according to claim 1, wherein the space between the crystalline structures or the lattice distance between crystals of each crystalline structure is controlled by changing the temperature of a heat treatment of the gas storage medium.

3. The gas storage method according to claim 1, wherein the space between the crystalline structures or the distance between crystals of each crystalline structure is controlled by introduction of a chemical reaction group during sample synthesis of the gas storage medium.

4. The gas storage method according to claim 3, wherein the chemical reaction group is an organic compound containing an amine group (NH₂).

5. The gas storage method according to claim 4, wherein the organic compound containing the amine group includes one or more selected from the group consisting of methylamine, ethylamine, propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, ammonia, dimethylamine, trimethylamine, and aniline.

6. The gas storage method according to claim 1, wherein the crystalline structure is formed in such a shape that a plurality of crystals are consecutively joined to form one crystalline structure as a whole.

7. The gas storage method according to claim 1, wherein the crystalline structure has a layered or cubical structure.

8. The gas storage method according to claim 1, wherein the crystalline structure includes a transition metal, a compound with a transition metal, or a transition metal oxide.

9. The gas storage method according to claim 8, wherein the transition metal includes one or more selected from the group consisting of Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, and Hg.

10. The gas storage method according to claim 1, wherein the crystalline structure is a vanadium pentoxide crystalline structure.
